(19) United States
(12) Patent Application Publication
(10) Pub. No.: US 2026/0332451 A1
(43) Pub. Date: Oct. 22, 2026

(54) PRIORITIZED NETWORK ACCESS FOR EMERGENCY SERVICES USING VIRTUAL CUSTOMER PREMISE EQUIPMENT (CPE) ARCHITECTURE

(71) Applicant: Charter Communications Operating, LLC, St. Louis, MO (US)

(72) Inventors: Timothy C. BLEIDORN, Colorado Springs, CO (US); Christopher J. TEAGUE, Highlands Ranch, CO (US); Peter Andrew ERICKSEN, Castle Rock, CO (US); Shane NEWBERG, Aurora, CO (US)

(21) Appl. No.: 19/185,932

(22) Filed: Apr. 22, 2025

(51) Int. Cl. H04L 12/46; H04L 47/2408; H04W 12/06; H04W 72/566; H04W 76/50

(52) U.S. Cl. CPC H04L 12/4633; H04L 47/2408; H04W 12/06; H04W 72/566; H04W 76/50; H04L 2212/00

(57) ABSTRACT

Various embodiments include a system for prioritizing emergency services communications in a network. The system may include an access point configured to receive a connection request from a user equipment (UE) device, an authentication server configured to authenticate the UE device based on credentials provided by the UE device, and a broadband network gateway/wireless access gateway (BNG/WAG). The BNG/WAG may be configured to receive an authentication response from the authentication server including a priority level for the UE device, assign a differentiated services code point (DSCP) value to network traffic associated with the UE device based on the priority level, and encapsulate the network traffic in a Generic Routing Encapsulation (GRE) tunnel between the access point and the BNG/WAG using the assigned DSCP value in both an outer header and an inner header of encapsulated packets.

### FIELD OF INVENTION

The present disclosure relates to network communication systems, and more particularly to prioritizing emergency services communications in a virtual customer premise equipment (CPE) architecture.

### BACKGROUND

Network communication systems have evolved to support a wide range of applications and services, from basic internet connectivity to complex enterprise networks. These systems typically involve multiple components working together to route data packets between devices and across different network segments. Key elements often include access points, routers, gateways, and authentication servers that collectively manage network traffic, security, and quality of service.

Recent developments in network architectures have introduced concepts like virtual customer premise equipment (virtual CPE) and software-defined networking (SDN). These approaches aim to increase flexibility and centralize network management by virtualizing certain network functions traditionally performed by dedicated hardware devices. Additionally, techniques such as differentiated services (DiffServ) and various tunneling protocols have emerged to enable more granular control over network traffic prioritization and routing across diverse network infrastructures.

### SUMMARY

This summary is provided to introduce concepts of various aspects in a simplified form that are further described below in the detailed description. This summary is not intended to identify key or essential features of the claimed subject matter, nor is it intended to be used as an aid in determining the scope of the claims.

Some aspects include a system for prioritizing emergency services communications in a network. The system may include an access point configured to receive a connection request from a user equipment (UE) device, an authentication server configured to authenticate the UE device based on credentials provided by the UE device, and a broadband network gateway (BNG) or wireless access gateway (WAG) (together BNG/WAG) configured to receive an authentication response from the authentication server, the authentication response including a priority level for the UE device. The BNG/WAG may be configured to assign a differentiated services code point (DSCP) value to network traffic associated with the UE device based on the priority level, and encapsulate the network traffic in a Generic Routing Encapsulation (GRE) tunnel between the access point and the BNG/WAG while maintaining the DSCP value in both an outer header and an inner header of encapsulated packets.

In some aspects, the authentication server may be configured to access a database of pre-registered priority devices and determine the priority level for the UE device based on a match between the credentials (e.g., a digital certificate) provided by the UE device and the database of pre-registered priority devices. In some aspects, the BNG/WAG may be further configured to assign the UE device to a virtual local area network (VLAN) based on the priority level and apply quality of service (QoS) policies to the network traffic associated with the UE device based on the assigned VLAN. In some aspects, the BNG/WAG may be further configured to receive network traffic from a content delivery network (CDN) addressed to the UE device, encapsulate the network traffic from the CDN in the GRE tunnel while maintaining the DSCP value in both the outer header and the inner header of encapsulated packets, and forward the encapsulated network traffic to the access point. In some aspects, the BNG/WAG may be further configured to perform network address and port translation (NAPT) on the network traffic from the CDN before encapsulating it in the GRE tunnel.

In some aspects, a method for prioritizing emergency services communications in a network system may include receiving, at an access point, a connection request from a UE device and forwarding credentials of the UE in the connection request to a BNG/WAG for authentication. The BNG/WAG may forward the credentials of the UE to an authentication server for authentication as a priority device. The authentication server may authenticate the UE device based on the credentials by accessing a database of priority devices, and forward the authentication results in an authentication response to the BNG/WAG, the authentication response including a priority level for the UE device. The method may include assigning by the BNG/WAG a DSCP value to network traffic associated with the UE device based on the priority level in the authentication response. The method may include encapsulating the network traffic in a GRE tunnel between the access point and the BNG/WAG while maintaining the DSCP value in both an outer header and an inner header of encapsulated packets.

In some aspects, a method performed by an access point for prioritizing emergency services communications in a network may include receiving a connection request from a UE device, forwarding authentication credentials provided by the UE device to a BNG/WAG for authentication, receiving from the BNG/WAG a priority level for handling communications to/from the UE device, encapsulating network traffic in a GRE tunnel between the access point and BNG/WAG while maintaining a DSCP value in both an outer header and an inner header of encapsulated packets, and transmitting the encapsulated network traffic to the BNG/WAG through the GRE tunnel.

In some aspects, a method performed by a BNG/WAG for prioritizing emergency services communications in a network may include receiving an authentication response from an authentication server, the authentication response including a priority level for a UE device, assigning a DSCP value to network traffic associated with the UE device based on the priority level, encapsulating the network traffic in a GRE tunnel between an access point and the BNG/WAG while maintaining the DSCP value in both an outer header and an inner header of encapsulated packets, and transmitting the encapsulated network traffic to the access point through the GRE tunnel.

In aspects, a method performed by an authentication, authorization, and accounting (AAA) server for prioritizing emergency services communications in a network may include receiving an authentication request for a UE device from a BNG/WAG, accessing a database of pre-registered priority devices, determining a priority level for the UE device based on a match between credentials provided by the UE device and the database of pre-registered priority devices, generating an authentication response including the determined priority level for the UE device, and transmitting the authentication response to the BNG/WAG. Some aspects may further include the AAA server accessing the database and determining the priority level of the UE in response to a priority indication included in a realm field of the UE device's Network Access Identifier (NAI).

Further aspects may include a computing device having a processing system configured with processor-executable instructions to perform operations corresponding to any of the methods summarized above. Further aspects may include a non-transitory processor-readable storage medium having stored thereon processor-executable instructions configured to cause a processing system to perform operations corresponding to any of the methods summarized above. Further aspects may include a computing device having various means for performing functions corresponding to any of the method operations summarized above.

### BRIEF DESCRIPTION OF THE FIGURES

The accompanying drawings, which are incorporated herein and constitute part of this specification, illustrate exemplary embodiments of the claims, and, together with the general description given and the detailed description, serve to explain the features herein.

FIG. 1A is a virtual CPE network architecture for enabling prioritized network access according to various embodiments.

FIG. 1B is a packet addressing diagram showing packet encapsulation in a network communication system according to various embodiments.

FIG. 2 is a sequence diagram illustrating communication flow for prioritizing emergency services traffic according to various embodiments.

FIG. 3A is a block diagram of an access point system according to various embodiments.

FIG. 3B is a block diagram of a BNG/WAG system according to various embodiments.

FIG. 3C is a block diagram of an AAA server system according to various embodiments.

FIG. 4 is a process flow diagram of a method for handling network traffic in a virtual CPE architecture according to various embodiments.

FIG. 5 is a process flow diagram of a method for handling network traffic prioritization according to various embodiments.

FIG. 6 is a process flow diagram of a method for processing authentication requests according to various embodiments.

FIG. 7 is a section view of a mobile device according to various embodiments.

FIG. 8 is a perspective view of a server according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include a system and method for prioritizing emergency services communications in a network using a virtual customer premise equipment (CPE) architecture. Various embodiments utilize Generic Routing Encapsulation (GRE) tunneling using the same differentiated services code point (DSCP) marking of both the outer header and the inner header of encapsulated packets to maintain priority designations across network segments, ensuring that emergency communications receive preferential treatment even in congested network conditions.

The prioritization system of various embodiments enables seamless integration of emergency services devices into existing virtual CPE network infrastructures, allowing first responders, emergency data devices, and other critical personnel to maintain reliable, high-priority communications. By leveraging authentication servers, broadband network gateways, and access points in concert, the system can dynamically assign and enforce quality of service policies based on device credentials, enhancing network responsiveness during emergencies.

The terms “emergency user equipment (UE)” and “priority UE” are used herein to refer to (but not limited to) any one or all of mobile communication devices, cellular telephones, smartphones, laptop computers, portable medical devices (e.g., portable electrocardiogram devices), emergency and first responder equipment, and other similar computing and communication devices that include a wireless transceiver capable of Wi-Fi communications, a memory for storing data and machine-executable instructions, and a programmable processing system that may be configured to provide the functionality of various embodiments.

The terms “computing system” and “network computing systems” are used herein to refer to (but not limited to) any one or all of servers, workstations, desktop computers, programmable network devices, and other similar computing systems that include a memory for storing documents and a programmable processing system that may be configured to provide the functionality of various embodiments.

The term “processing system” is used herein to refer to one or more processors, including multi-core processors, graphics processing units (GPU), neural network processing units (NPU), microprocessor units (MPU), arithmetic logic units (ALU), memory systems, etc., that are organized and configured to perform computing functions of various embodiments as described herein.

Existing wireless network architectures often struggle to provide differentiated quality of service (QoS) for emergency communications, particularly in virtual CPE environments based on Wi-Fi communications. Related Wi-Fi network systems rely on static QoS policies or prioritization at the customer premises, which becomes challenging when network functions are virtualized and centralized. Additionally, related Wi-Fi network systems often fail to maintain end-to-end QoS markings across different network segments, especially when traffic is encapsulated for transmission between network elements. This limitation is particularly problematic for emergency services communications that require consistent high-priority treatment throughout the network.

In emergency situations, reliable communication is important for first responders and emergency personnel to coordinate their efforts effectively. While cellular networks have established systems for prioritizing communications of priority UE devices, these systems may not always be accessible or reliable in certain locations. For instance, in buildings where cellular signals struggle to penetrate, Wi-Fi networks may be the only available wireless link. As a result, there is a growing need to support priority communications over Wi-Fi networks to ensure that emergency services can maintain consistent and reliable connectivity, even in areas where cellular coverage is limited or unavailable. This capability may enhance the overall effectiveness of emergency response efforts and improve public safety outcomes in a variety of challenging environments.

In emergency situations, it is common for a large number of individuals to simultaneously attempt to use wireless communications, which may lead to network congestion and overloading, particularly in Wi-Fi networks. This surge in network traffic can result in degraded performance or complete loss of wireless connectivity for all users, including emergency responders and priority personnel. Current virtual CPE networks may lack the capability to effectively prioritize wireless communications for emergency and priority users under these high-demand conditions. As a result, public safety may be improved by enhancing virtual CPE networks with the ability to dynamically identify, prioritize, and maintain reliable wireless communications for emergency services and priority personnel, even in scenarios where the network is experiencing heavy congestion. This capability may help ensure that high-priority communications remain functional and effective during emergencies, potentially improving overall public safety outcomes.

Various embodiments provide methods and systems for supporting priority emergency services communications in virtual CPE architectures. Specifically, various embodiments solve the problem of maintaining consistent QoS prioritization for priority traffic across different network segments and address spaces. By leveraging authentication mechanisms, DSCP marking, and GRE tunneling, various embodiments ensures that emergency communications receive appropriate priority treatment from end to end. This approach overcomes the limitations of traditional static QoS policies and enables dynamic prioritization based on device credentials and network conditions, even when network functions are virtualized and centralized away from the customer premises.

In various embodiments, DSCP may be utilized as a mechanism for marking and prioritizing IP packets to manage QoS in networks. DSCP may involve a 6-bit field within the Type of Service (ToS) octet in the IPv4 packet header, which may be used to classify network traffic and manage QoS prioritization. This field may define a per-hop behavior (PHB) that specifies how packets are handled by network devices, potentially allowing for differentiated treatment based on priority levels. The DSCP field may include Class Selector Bits, which may define the traffic class, and Drop Precedence Bits, which may indicate the likelihood of a packet being discarded under network congestion. In some implementations, a specific DSCP value, such as DSCP 24, may correspond to Class Selector 3 (CS3) and may be represented in binary as 011000. This value may designate a moderate priority level and may be typically used for network management traffic, control plane communications, and other mission-critical but non-interactive applications. By utilizing designated DSCP values, networked systems may implement priority-based processing, potentially enabling optimized handling of packets based on application-specific requirements.

In various embodiments, GRE may be utilized as a tunneling protocol to encapsulate network packets for secure transport over another IP network. GRE tunneling may provide a mechanism to create a virtual point-to-point link between network devices, potentially enabling the transmission of various network protocols across intermediate networks. In some implementations, GRE tunneling may involve encapsulating the original packet within an outer IP packet, which may allow for the preservation of the original packet's routing information. Within the GRE tunnel, a second Ethernet layer may be included, which may define another set of source and destination MAC addresses and frame control information for intra-tunnel data transmission. The encapsulated IP layer, following the second Ethernet layer, may represent the original network-layer addressing and routing information for the tunneled packet, potentially enabling proper delivery of the payload within the GRE-encapsulated transmission. This approach may facilitate the secure and efficient transmission of priority traffic between network elements, such as from a Wi-Fi virtual CPE to a market-based broadband network gateway and/or wireless access gateway (BNG/WAG), while maintaining the integrity of QoS markings and priority designations.

While multiple computing devices within a virtual CPE network may be modified to support implementation of various embodiments, three network elements may be most involved in supporting priority communications, the access point, a BNG/WAG that also functions as a wide-area network gateway (WAN), and an authentication, authorization, and accounting (AAA) server or network device.

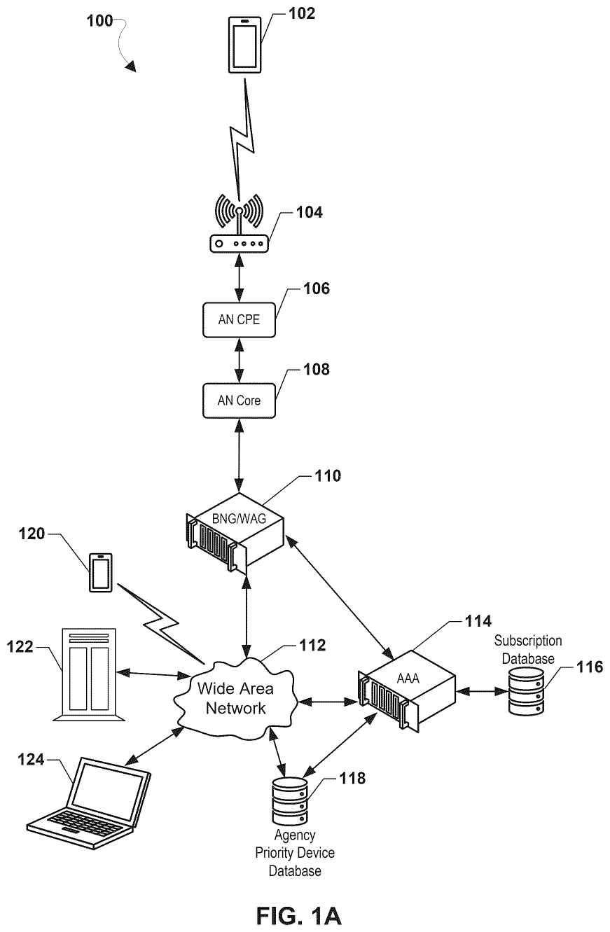

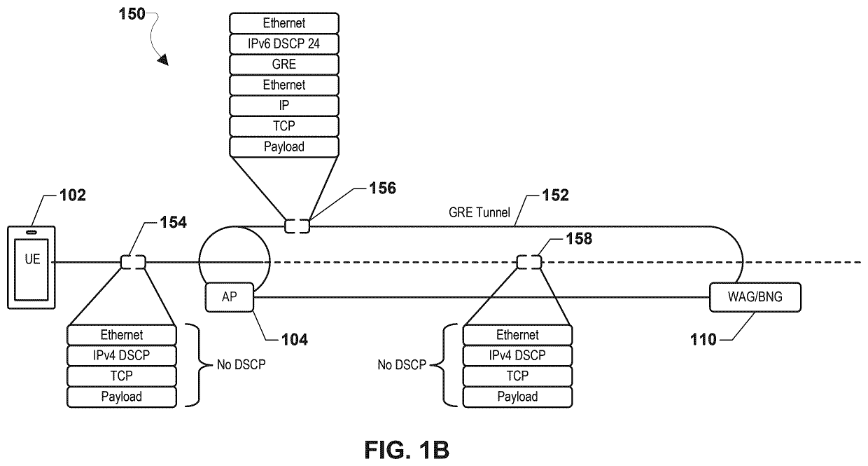

FIG. 1A illustrates an example of the virtual CPE network architecture 100. A virtual CPE network architecture 100 may include multiple components arranged in a hierarchical structure to facilitate communication between mobile devices and network resources.

A virtual CPE network architecture 100 may include a priority UE device 102 that communicates with a wireless access point 104. The wireless access point 104 may be configured to receive a connection request from the priority UE device 102, which may be considered a UE device in this context. The wireless access point 104 may connect to an access network CPE 106, which in turn may link to an access network core 108. The access network core 108 may connect to a BNG/WAG 110 that manages network traffic and routing, such as traffic from a content delivery network (CDN) intended for a UE device 102 on the network. The BNG/WAG 110 may communicate, directly or via a network 112, with an AAA server or network device 114 that has access to a subscriber database 116 to coordinate authentication and authorization of UE devices as well as accounting for usage of the network if implemented. Once a UE device is onboarded to the virtual CPE network 100, the UE device can engage in communications with remote devices, such as other UE devices 120, remote servers 122, and other computers 124.

The components of the virtual CPE network architecture 100 may work in combination to perform various operations for prioritizing emergency services communications. In various embodiments, the wireless access point 104, BNG/WAG 110, and AAA server 114 may collaborate to authenticate priority devices, assign priority levels, and manage network traffic accordingly.

In various embodiments, the virtual CPE network architecture 100 may facilitate communications to/from a priority UE device 102 with emergency and agency resources including UE devices 120, servers 122, and computers 124, even during emergency situations. This architecture may enable the priority UE device 102 to maintain connectivity and access to agency network resources through the wireless access point 104, regardless of network congestion or disruptions that may occur during emergencies.

The access point may receive connection requests from UE devices and forward authentication credentials to the BNG/WAG for verification. In some embodiments, the UE device may provide secure credentials, such as an encrypted certificate that can be used by the AAA to authenticate the UE device as described herein.

In some embodiments, the UE device may also include an indication that the device is entitled to priority in the realm field of the Network Access Identifier (NAI). Such an indicator in the NAI may inform the access point and subsequent network elements, such as the AAA server 114, that the UE device proports to be a priority device. The NAI, defined by the Internet Engineering Task Force (IETF) in RFC 7542, provides a consistent format for identifying UEs so that networks can authenticate and authorize them, even when the UE attempts to access services outside their home network. The realm typically corresponds to the domain or administrative authority responsible for authenticating and authorizing the user, but can include multiple subdomains separated by periods to provide additional device identity or affiliation information. Including a priority indication in the realm field of the NAI may enable the UE device to alert network elements, such as the BNG/WAG 110 and AAA server 114 that priority authentication processes of various embodiments should be initiated. Including an official or priority domain in the realm field of the NAI may also assist in providing network access to priority UE devices that have not registered with the network previously (i.e., presenting an SSID that has not been seen before by the access point).

Non-limiting examples of a priority indicator that can be included in the UE device's NAI realm field include a priority organization domain (e.g., a police, fire, ambulance, military, government or a similar domain identifier), a subdomain indicating priority within the organization domain, an alphanumeric priority code within a subdomain that is recognized by most networks, or other indicator of priority.

Upon successful authentication, the access point may receive priority level information and network parameters from the BNG/WAG, which may include VLAN assignments and QoS policies. The access point may then apply these parameters to the network traffic associated with the authenticated UE device. In some implementations, the access point may encapsulate outgoing packets using GRE tunneling, maintaining DSCP values in both the outer and inner headers to ensure end-to-end QoS enforcement. The access point may also handle incoming traffic by decapsulating packets received through the GRE tunnel and forwarding them to the appropriate UE device. Additionally, the access point may manage traffic prioritization and contention scenarios, ensuring that high-priority devices maintain network access even during periods of heavy network congestion.

In various embodiments, the BNG/WAG 110 may play a central role in managing and enforcing priority communications within the virtual CPE network architecture. The BNG/WAG 110 may receive authentication requests from access points and forward them to the AAA server for credential verification. Upon receiving the authentication response, the BNG/WAG 110 may apply service policies, including assigning priority VLANs, marking traffic with appropriate DSCP values, and configuring GRE encapsulation endpoints. For outgoing traffic, the BNG/WAG 110 may encapsulate packets in GRE tunnels, maintaining DSCP markings in both inner and outer headers to ensure consistent prioritization across network segments. The BNG/WAG 110 may also handle return traffic, preserving priority markings and applying downstream shaping and policy enforcement. In some implementations, the BNG/WAG 110 may support multiple priority tiers and implement hierarchical Quality of Service UE to differentiate between various types of priority traffic. Additionally, the BNG/WAG 110 may perform Network Address and Port Translation (NAPT) while preserving priority markings, ensuring seamless integration with external networks.

The BNG/WAG 110 may connect to a wide-area network (WAN) 112 (e.g., the Internet), supporting communications with external networks and resources. In various embodiments, the BNG/WAG 110 may serve as a central point of control in the virtual CPE network architecture, managing traffic flow, enforcing QoS policies, and maintaining priority designations for emergency services communications. The BNG/WAG 110 may be configured to support the encapsulation and routing of prioritized network traffic through GRE tunnels, ensuring that DSCP markings are preserved across network segments, and dynamically applying QoS policies based on the authentication and priority levels determined for each UE device.

In various embodiments, the Authentication, Authorization, and Accounting (AAA) server 114 may play a role in managing priority device access and policy enforcement within the virtual CPE network architecture. The AAA server 114 may receive authentication requests from the BNG/WAG 110 when a UE device attempts to connect to the network. Upon receiving a request, the AAA server 114 may query the subscriber database 116 or an external agency database 118 to validate the UE device's credentials and determine its priority status. In some embodiments, the UE device may be configured with a special NAI that includes a priority domain, priority sub-domain, priority code in a sub-domain, or other indicator of priority in the realm field, which may prompt the AAA server 114 to perform the priority authentication functions of querying query the subscriber database 116 or an external agency database 118 to validate the UE device's credentials and determine its priority status.

In instances in which the UE device is authenticated as a priority device, the AAA server 114 may assign a service policy to the device, including DSCP markings, VLAN assignments, and QoS parameters. The server may then generate an Access Accept message containing these policy attributes and send it to the BNG/WAG 110 for implementation. In some cases, the AAA server 114 may support multiple priority tiers, allowing for differentiated handling of emergency services traffic. Additionally, the AAA server 114 may maintain and update the subscriber database, ensuring that verified devices receive priority access. By coordinating with other network elements, the AAA server 114 may enable dynamic and secure prioritization of emergency communications across the virtual CPE network.

The AAA server 114 may be configured to authenticate the priority UE device 102 based on credentials provided by the priority UE device 102. Again, this action may be performed in response to recognizing a priority indication in the realm field of the UE device's NAI. In some embodiments, the AAA server 114 may communicate with a network subscriber database 116 and/or an agency priority device database 118 to verify device credentials and priority status. The BNG/WAG 110 may be configured to receive an authentication response from the AAA server 114, which may include a priority level for the priority UE device 102.

FIG. 1B is a packet addressing diagram 150 showing a structure of packet encapsulation used in the virtual CPE network 100. In some embodiments, the virtual CPE network architecture 100 may utilize a packet addressing and encapsulation scheme to facilitate communication between network components. A GRE tunnel 152 that facilitates communication between the wireless access point 104 and the BNG/WAG 110. The GRE tunnel 152 may enable the encapsulation of network traffic to maintain priority designations across network segments.

In some embodiments, a communication packet 154 may contain multiple protocol layers. The communication packet 154 may include Ethernet, IPv6 DSCP24, Ethernet, IP, TCP, and payload components. The IPv6 DSCP24 component may represent a DSCP value assigned to the packet for prioritization purposes.

The BNG/WAG 110 may be configured to encapsulate the network traffic in the GRE tunnel 152 between the wireless access point 104 and the BNG/WAG 110. During this encapsulation process, the BNG/WAG 110 may use the same DSCP value to mark both the outer header and an inner header of encapsulated packets to ensure consistent prioritization of network traffic.

A GRE encapsulation packet 156 illustrated in FIG. 1B represents the packet structure after encapsulation. The GRE encapsulation packet 156 may contain protocol layers such as Ethernet, IP, TCP, and payload. In some cases, the outer header may be added to the network traffic while preserving the inner header.

The wireless access point 104 may also be configured to encapsulate network traffic in the GRE tunnel 152. When encapsulating the network traffic, the wireless access point 104 may use the same DSCP value in both an outer header and an inner header of encapsulated packets, such as by copying the DSCP value from the inner header to the outer header during the encapsulation process.

In FIG. 1B, the communication packet 158 show the packet configuration within and after the GRE tunnel with protocol layers including Ethernet, IPv4 DSCP, TCP, and payload components. This configuration may be used for network traffic received from a CDN addressed to the priority UE device 102.

The BNG/WAG 110 may be further configured to encapsulate the network traffic from the CDN in the GRE tunnel 152. When encapsulating this traffic, the BNG/WAG 110 may use the same DSCP value to mark both the outer header and the inner header of encapsulated packets. In some cases, this may involve the BNG/WAG 110 using the DSCP value assigned to the network traffic packets by copying the DSCP value from the inner header and using it to mark the outer header of the encapsulating packets.

The packet addressing diagram 150 illustrates how packets are structured and encapsulated as they traverse through different network segments. The GRE tunnel 152 may provide a pathway for transmitting these encapsulated packets between the wireless access point 104 and the BNG/WAG 110, while maintaining the various protocol layers and addressing information needed for proper packet routing and delivery.

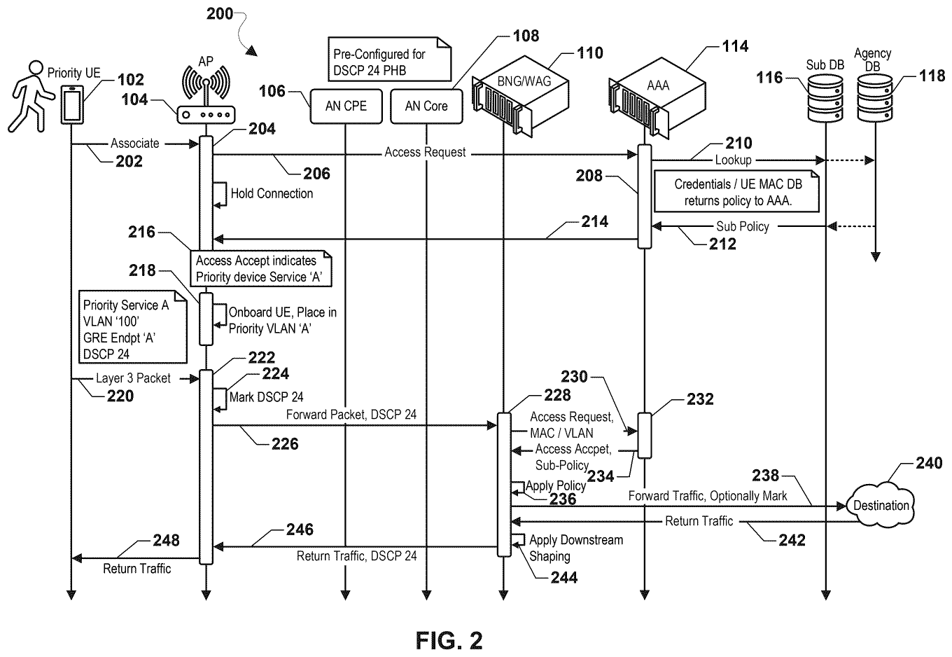

FIG. 2 is a message flow diagram 200 illustrating the exchange of messages and information between various network elements that may be involved in implementing various embodiments.

Registration of a priority UE with a virtual CPE network may begin with an UE-to-AP associate message 202 sent by the priority UE device 102 to a wireless access point 104. This UE-to-AP associate message 202 may initiate the connection process for the priority UE device 102 to join the network. In the case of a priority UE, this UE-to-AP associate message 202 may include device credentials such as a digital certificate, a unique device identifier, an encrypted authentication token, or a priority access code that may be used by the network elements (e.g., the AAA server 114) to authenticate the UE and determine the priority status of the requesting UE device 102. In some embodiments, the UE-to-AP associate message 202 may include the device's NAI with an indication in the realm field (e.g., within the device's network domain affiliation or a subdomain) that the device is or may be entitled to priority service. As explained above, by using SSIDs, priority UE devices 102 may access virtual CPE Wi-Fi networks without traditional permission or passwords, potentially enabling emergency communications to be established seamlessly across various network configurations.

In response to receiving the UE-to-AP associate message 202, the wireless access point 104 may establish an AP open socket 204 for operations associated with authenticating the UE as a priority UE device. The AP open socket 204 may represent a communication channel that remains open for priority verification before allowing network access. In some embodiment, the wireless access point 104 may not allow the priority UE device 102 to transmit or receive data until authentication and priority status of the UE are verified.

The wireless access point 104 may generate an access request message 206 to the BNG/WAG 110 to initiate the authentication process. This message may contain the credentials of the priority UE device 102 received in the UE-to-AP associate message 202. In some implementations, the access request message 206 may be sent via the GRE tunnel 152 between the wireless access point 104 and the BNG/WAG 110, as illustrated in FIG. 1B.

Upon receiving the access request message 206, the BNG/WAG 110 may forward the access request message 206, or some of the information in that message (e.g., UE credentials, NAI, etc.), to the AAA 114 through direct or indirect (e.g., via a network 112) communications links with the AAA 114.

The AAA server 114 may open a socket 208 for operations associated with looking up the UE device and initiate a priority database lookup request 210 to a subscriber database 116 or an agency database 118 that stores the identities and priority information of priority UE devices. In some embodiments, the AAA server 114 may initiate this authentication process in response to recognizing a priority indication or code within the UE device's NAI realm field. This request may involve accessing the network subscriber database 116 or the agency priority device database 118 using information provided by the UE in the UE-to-AP associate message 202 to authenticate the priority UE device 102 and determine its priority status.

After completing the database lookup, the subscriber database 116 or agency database 118 may send a database lookup response 212 to the AAA 114. This response may contain information about the authentication status and priority level of the priority UE device 102, as well as communication policies to be used in supporting communications from/to the priority UE device.

The AAA server 114 may use information in the database lookup response 212 received from the subscriber database 116 or agency database 118 to create an access request response message 214 that is sent to the access point 104 via the BNG/WAG 110. In some embodiments, the AAA server 114 may inform the BNG/WAG 110 regarding priority policies that should be applied to communications with the authenticated UE device, such as identifying a VLAN value, a DSCP value, or a policy by name based on information associated with the user obtained from the subscriber database 116 or agency database 118. The BNG/WAG 110 may use the information received from the AAA server 114 (e.g., network policy, VLAN, DSCP value, etc.) to establish an appropriate communication link with the UE device, such as implementing and informing the access point regarding a priority VLAN, DSCP value, and/or other network policies associated with the UE device, and forwarding the request response message 214. The access request response message 214 may include response message content 216, which may contain the authentication results and the determined priority level for the priority UE device 102.

Upon receiving the access request response message 214, the access point 104 may initiate UE connection operations 218. These operations may involve onboarding the UE to the network, assigning network parameters, such as a priority VLAN, and preparing for the connection of the priority UE device 102. Configuring the network connection for the priority UE device 102 in operations 218 may include designating the communication link as a priority service, using a particular VLAN (e.g., 100), designating the GRE tunnel endpoint (e.g., “A”) and configuring the access point to include a particular DSCP value, such as 24, in communication packets from the UE device routed through the GRE tunnel to the BNG/WAG 110.

Once connected to the network for priority service, the priority UE device 102 may generate a layer 3 packet 220 for transmission. This packet may represent the actual data that the priority UE device 102 intends to send over the network.

In the context of network communications, Layer 2 and Layer 3 refer to different levels of the Open Systems Interconnection (OSI) model. Layer 2, the data link layer, may be responsible for frame-based communication within a local network segment and may operate using Media Access Control (MAC) addresses to identify and forward packets between devices within the same network. Layer 3, the network layer, may manage packet-based communication across different network segments and may use IP addresses to route packets between subnets. When a packet is transmitted from one subnet to another in an Internet Protocol version 4 (IPv4) network, a Layer 3 process, such as routing, may occur. The access point 104 may examine the destination IP address, determine the next-hop address, and encapsulate the packet with a new Layer 2 frame containing the MAC address of the next-hop device. This transition from Layer 2 switching to Layer 3 routing may enable efficient data transmission across network boundaries while maintaining address resolution through mechanisms such as the Address Resolution Protocol (ARP), which may map IP addresses to MAC addresses.

The wireless access point 104 may establish an open communication session 222 to handle the network traffic associated with the priority UE device 102. During this session, the wireless access point 104 may perform packet marking with a priority DSCP value 224, such as DSCP 24. This operation may involve assigning a DSCP value to the network traffic based on the priority level of the priority UE device 102 that was received from the BNG/WAG 110 or AAA server 114.

After marking communication packets from the priority UE device 102, the wireless access point 104 may encapsulate the network traffic and forward the packets in communication 226 to the BNG/WAG 110 via the GRE tunnel 152.

Upon receiving the encapsulated packet, the BNG/WAG 110 may perform priority packet processing 228. This may involve examining the DSCP value and applying appropriate quality of service policies based on the packet's priority level.

The BNG/WAG 110 may then generate a packet access request 230 to the AAA server 114 to determine how to handle the received packets. This request may be processed during the packet access request processing operation 232.

Following this processing, a packet access response 234 may be generated and provided by the AAA server 114. Based on this response, the BNG/WAG 110 may perform a policy application operation 236, which may involve applying specific network policies based on the packet's priority level.

The BNG/WAG 110 may proceed with packet transmission 238, forwarding the packets to its intended wide-area network destination 240, such as another UE 120, an agency server 122, or other computer 124 accessible via the wide-area network 112 as described with reference to FIG. 1A.

For incoming traffic, return traffic packets 242 of network traffic may be received from the destination or source 240, with packets addressed for delivery to the priority UE device 102. The BNG/WAG 110 may perform downstream shaping operations 244 on return traffic packets 242, such as applying quality of service policies to ensure that high-priority traffic receives preferential treatment. The BNG/WAG 110 may then encapsulate the return traffic packets 242 and send them as return packets 246 via GRE tunnel 152 to the wireless access point 104.

The wireless access point 104 may receive this encapsulated network traffic from the BNG/WAG 110 through the GRE tunnel 152. The wireless access point 104 may decapsulate the received network traffic, and forward the decapsulated network traffic as return packets to UE 248 to the priority UE device 102.

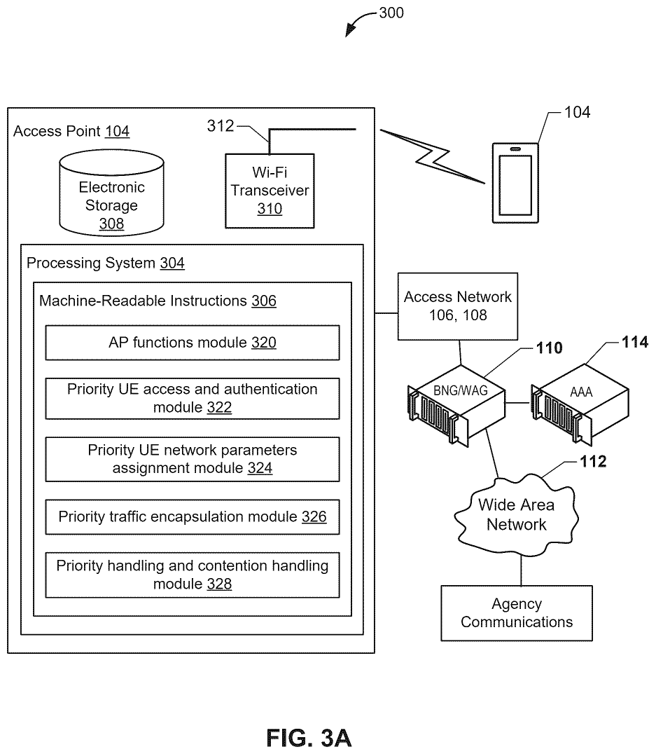

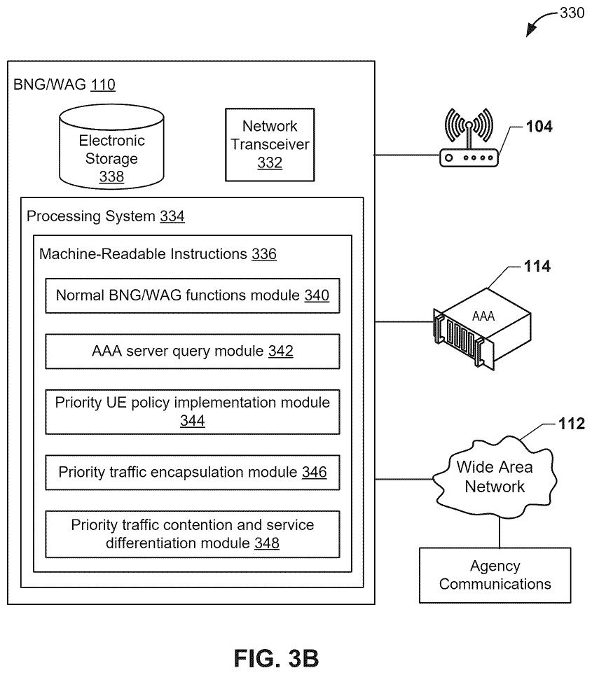

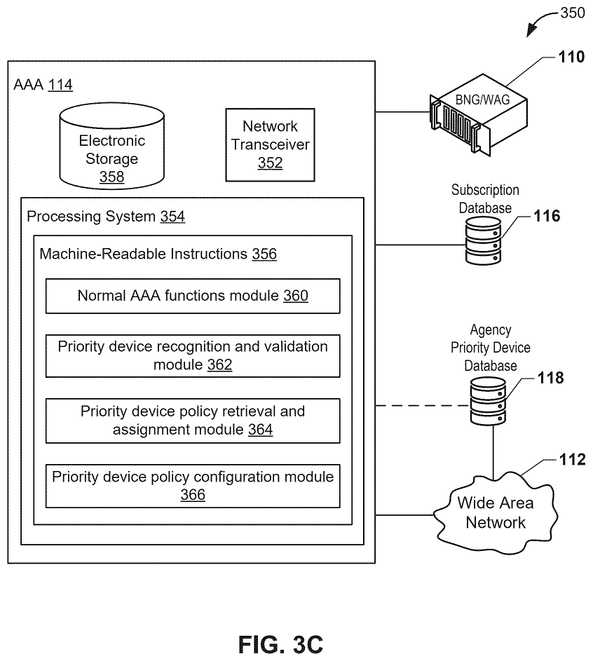

As described above, the virtual CPE network architecture 100 includes an access point 104, a system diagram 300 of which is illustrated in FIG. 3A. With reference to FIGS. 1A-3A, the wireless access point 104 may include a Wi-Fi transceiver 310 connected to a Wi-Fi antenna 312. The Wi-Fi transceiver 310 and Wi-Fi antenna 312 may enable wireless communication between the wireless access point 104 and other devices, such as the priority UE device 102. The Wi-Fi transceiver 310 or another network transceiver (not shown) may also enable the access point 104 to communicate via wired or wireless network connections with the access network devices 106, 108, and BNG/WAG 110 as described herein.

The access point may include a processing system 304 that executes machine readable instructions 306 stored in electronic storage 308. The processing system 304 may be responsible for managing the various operations and functions of the wireless access point 104.

The machine-readable instructions 306 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The machine readable instructions 306 may include several modules that work together to handle both priority and non-priority network traffic. These modules may include an access point functions module 320, a priority UE access and authentication module 322, a priority UE network parameters assignment module 324, a priority traffic encapsulation module 326, and a priority handling and contention handling module 328.

The access point functions module 320 may include instructions to cause the processing system 304 to perform operations including standard wireless access point functions, such as managing connections, routing traffic, and maintaining network security.

The priority UE access and authentication module 322 may include instructions to cause the processing system 304 to perform operations including receiving connection requests from UE devices, such as the priority UE device 102, and forwarding authentication credentials to the BNG/WAG 110 for verification.

In some embodiments, the priority UE network parameters assignment module 324 may include instructions to cause the processing system 304 to perform operations including receiving and applying network parameters for authenticated priority UE devices. These parameters may include virtual local area network (VLAN) assignments and quality of service UE policies received from the BNG/WAG 110.

The priority traffic encapsulation module 326 may include instructions to cause the processing system 304 to perform operations including encapsulating and transmitting network traffic in the GRE tunnel 152 between the wireless access point 104 and the BNG/WAG 110. This module may perform packet header manipulation operations to use the same DSCP values to mark both outer and inner headers of encapsulated packets, such as by copying the DSCP value from the inner header and marking the outer header with the same value. The priority traffic encapsulation module 326 may include instructions to decapsulate network traffic received from the BNG/WAG through the GRE tunnel and forward the decapsulated network traffic to the priority UE device 102.

In some embodiments, the priority handling and contention handling module 328 may include instructions to cause the processing system 304 to perform operations including managing traffic prioritization and resolving contention between priority and non-priority traffic. This module may also apply the received QoS policies to network traffic associated with UE devices. In instances in which contention for network resources among multiple accessing devices occurs, the module may include instructions to favor communications from various priority UE devices according to their individual priorities as indicated in authentication and policy information received from the BNG/WAG and/or AAA as described with reference to FIG. 2.

The wireless access point 104 may receive a VLAN assignment for a UE device from the BNG/WAG 110. The priority UE network parameters assignment module 324 may apply this VLAN assignment to the network traffic associated with the UE device. This module may also apply the received QoS policies to network traffic associated with UE devices. The wireless access point 104 may receive QoS policies for a UE device from the BNG/WAG 110. The priority handling and contention handling module 328 may apply these QoS policies to the network traffic associated with the UE device, ensuring that priority traffic receives appropriate treatment.

The software modules within the machine readable instructions 306 may work together to provide differentiated handling of priority and non-priority traffic through the wireless access point 104. For example, when a packet is received from a priority UE device, the priority traffic encapsulation module 326 may encapsulate the packet while maintaining its DSCP value, and the priority handling and contention handling module 328 may ensure that the packet receives priority treatment based on the applied QoS policies.

The electronic storage 308 may include non-transitory storage media that electronically stores information. The electronic storage media of electronic storage 308 may include one or both system storage that is provided integrally (i.e., substantially non-removable) and/or removable storage that is removably connectable to the access point 104 (e.g., via a universal serial bus (USB) port, a firewire port, etc.). Electronic storage 308 may include one or more virtual storage resources (e.g., cloud storage, a virtual private network, and/or other virtual storage resources). Electronic storage 308 may store software algorithms, information determined by the processing system(s) 304, priority and communication policy information received from the BNG/WAG or AAA server, or other information that enables the access point 104 to function as described herein.

The description of the functionality provided by the different modules 320-328 is for illustrative purposes, and is not intended to be limiting, as any of modules 320-328 may provide more or less functionality than is described. For example, one or more of the modules 320-328 may be eliminated, and some or all of a module's functionality may be provided by other modules. As another example, the processing system(s) 304 may be configured to execute one or more additional modules that may perform some or all of the functionality of the modules 320-328.

As described above, the virtual CPE network architecture 100 includes a BNG/WAG 110, components of which are illustrated the system diagram 330 in FIG. 3B.

The BNG/WAG system diagram 330 may include a network transceiver 332 that enables communication with other network components, including the wireless access point 104, the AAA 114, and a wide area network 112 (e.g., the Internet) to enable a variety of emergency and agency communications as described herein.

The BNG/WAG 110 may also include a processing system 334 that executes machine readable instructions 336 stored in electronic storage 338. The processing system 334 may be responsible for managing the various operations and functions of the BNG/WAG 110.

The machine-readable instructions 336 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The machine readable instructions 336 may include several modules that work together to handle network traffic prioritization and service levels. These modules may include a Normal BNG/WAG functions module 340, an AAA server query module 342, a priority UE policy implementation module 344, a priority traffic encapsulation module 346, and a priority traffic contention and service differentiation module 348.

The Normal BNG/WAG functions module 340 may include instructions to cause the processing system 334 to perform operations including standard gateway operations, such as routing traffic and managing network connections.

The AAA server query module 342 may include instructions to cause the processing system 334 to perform operations including communicating with the AAA server 114 for authentication and authorization functions. This module may be responsible for forwarding authentication requests to and receiving authentication responses from the AAA server.

The priority UE policy implementation module 344 may include instructions to cause the processing system 334 to perform operations including implementing communication policies for individual priority UE devices 102 according to policies received from the AAA server. Such operations may include assigning the priority UE device 102 to a UE based on the priority level received from the AAA server 114. This module may also apply quality of service UE policies to the network traffic associated with the priority UE device 102 based on the assigned VLAN. This module may also assign a DSCP value to network traffic and mark the header of network traffic packets with the assigned value.

The priority traffic encapsulation module 346 may include instructions to cause the processing system 334 to perform operations including encapsulating network traffic in the GRE tunnel 152 between the wireless access point 104 and the BNG/WAG 110. This module may use the same DSCP values to mark both outer and inner headers of encapsulated packets. Such operations may include copying the assigned DSCP value from the header of packets that are being encapsulated (i.e., the inner header) and using the same value to mark the outer header of the encapsulating packets.

In some embodiments, the priority traffic contention and service differentiation module 348 may include instructions to cause the processing system 334 to perform operations including managing traffic prioritization and resolving contention between priority and non-priority traffic. This module may assign DSCP values to network traffic associated with the priority UE device 102 based on the priority level received from the AAA server 114.

The BNG/WAG 110 may be configured to receive network traffic from a CDN addressed to the priority UE device 102. In some cases, the priority traffic encapsulation module 346 may encapsulate this network traffic from the CDN in the GRE tunnel 152 while maintaining the DSCP value in both the outer header and the inner header of encapsulated packets.

In some embodiments, the Normal BNG/WAG functions module 340 may include instructions to cause the processing system 334 to perform operations including network address and port translation (NAPT) on network traffic. The BNG/WAG 110 may perform NAPT on the network traffic from the CDN before encapsulating it in the GRE tunnel 152.

Network Address and Port Translation (NAPT) is a technique used in IPv4 networks to enable multiple devices within a private network to share a single public IP address for communication over the Internet. In some implementations, NAPT may operate by mapping the private IP addresses and transport-layer port numbers of outbound packets to a single public IP address while assigning unique port numbers to each connection. In instances in which a packet is transmitted from a device within the private network to an external destination, the NAPT gateway may modify the source IP address to the public IP address and replace the source port with a dynamically assigned port. Upon receiving a response from the external destination, the NAPT gateway may use a translation table to match the destination port in the returning packet to the corresponding private IP address and port of the original sender, potentially ensuring that the packet is properly routed back to the originating device. This mechanism may allow efficient utilization of limited IPv4 address space, enable secure internal network structuring, and support multiple simultaneous network connections while maintaining transparent communication between private network devices and external hosts.

The priority traffic encapsulation module 346 may include instructions to cause the processing system 334 to perform operations including forwarding the encapsulated network traffic to the wireless access point 104 through the GRE tunnel 152. This may apply to both traffic originating from the priority UE device 102 and traffic received from the CDN.

In some cases, the priority UE policy implementation module 344 and the priority traffic contention and service differentiation module 348 may work together to ensure that QoS policies are applied consistently to network traffic associated with the priority UE device 102. These modules may use the assigned VLAN and DSCP values to prioritize traffic and manage network resources effectively.

The modules within the machine readable instructions 336 may work together to provide differentiated handling of priority and non-priority traffic through the BNG/WAG 110. For example, when a packet is received from a CDN, the Normal BNG/WAG functions module 340 may perform NAPT, the priority traffic encapsulation module 346 may encapsulate the packet while maintaining its DSCP value, and the priority traffic contention and service differentiation module 348 may ensure that the packet receives priority treatment based on the applied QoS policies.

The electronic storage 338 may include non-transitory storage media that electronically stores information. The electronic storage media of electronic storage 338 may include one or both system storage that is provided integrally (i.e., substantially non-removable) and/or removable storage that is removably connectable to the access point 104 (e.g., via a USB port, a firewire port, etc.). Electronic storage 338 may include one or more virtual storage resources (e.g., cloud storage, a virtual private network, and/or other virtual storage resources). Electronic storage 338 may store software algorithms, information determined by the processing system(s) 334, priority and communication policy information received from the AAA server 114, or other information that enables the BNG/WAG 110 to function as described herein.

The description of the functionality provided by the different modules 340-348 is for illustrative purposes, and is not intended to be limiting, as any of modules 320-348 may provide more or less functionality than is described. For example, one or more of the modules 320-348 may be eliminated, and some or all of a module's functionality may be provided by other modules. As another example, the processing system(s) 334 may be configured to execute one or more additional modules that may perform some or all of the functionality of the modules 340-348.

As described above, the virtual CPE network architecture 100 includes an AAA server 114, components of which are illustrated the system diagram 350 in FIG. 3C.

The AAA server 114 may include a network transceiver 352 that enables communication with other network components, such as the BNG/WAG 110, a subscription database 116, and an agency priority device database 118 either directly or indirectly via a wide-area network 112. The AAA server 114 may also include a processing system 354 that executes machine readable instructions 356 stored in electronic storage 358. The processing system 354 may be responsible for managing the various operations and functions of the AAA server 114.

The machine-readable instructions 356 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The machine readable instructions 356 may include several modules that work together to handle authentication, authorization, and policy management for priority devices. These modules may include a Normal AAA functions module 360, a priority device recognition and validation module 362, a priority device policy retrieval and assignment module 364, and a priority device policy configuration module 366.

The normal AAA functions module 360 may include instructions to cause the processing system 354 to perform operations including standard authentication, authorization, and accounting functions. This module may handle routine AAA operations for non-priority devices.

The priority device recognition and validation module 362 may include instructions to cause the processing system 354 to perform operations including receiving authentication requests for priority UE devices, such as the priority UE device 102, from the BNG/WAG 110 and recognizing and validating priority UE devices. This module may also validate the credentials provided by the UE devices in their access request messages (e.g., 202). This module may also include instructions to cause the processing system 354 to recognize and validate a UE in response to a priority indication in the realm field of the NAI of the UE device.

In some embodiments, the priority device recognition and validation module 362 may include instructions to cause the processing system 354 to perform operations including accessing a database or databases of pre-registered priority devices. Such databases may be the network subscriber database 116 or an agency priority device database 118 that maintains lists and priority information for UE devices authorized for priority communication status. In some implementations, the AAA server 114 may query external databases, such as a FEMA-managed priority device list, instead of maintaining its own internal database. In some embodiments, the NAI of the UE device may indicate the agency priority device database that the AAA server should access, such as by the agency's domain and/or a subdomain in the NAI realm field.

The priority device policy retrieval and assignment module 364 may include instructions to cause the processing system 354 to perform operations including determining a priority level for the UE device 102 based on a match between credentials provided by the UE device 102 and information in the database of pre-registered priority devices. In some embodiments, the credentials provided by the UE device 102 may include a digital certificate that the subscription database 116 and/or agency priority device database 118 can authenticate and use to lookup the priority and communication policies for a given priority UE.

The priority device policy configuration module 366 may include instructions to cause the processing system 354 to perform operations including generating an authentication response that includes the determined priority level for the UE device 102. In some embodiments, this module may include instructions for identifying network policies to use with the authenticated UE device, such as a particular VLAN, a DSCP value, and/or other policies. This module may also include instructions for transmitting the authentication response to the BNG/WAG 110.

In some embodiments, the priority device recognition and validation module 362 and the priority device policy retrieval and assignment module 364 may work together to process authentication requests and determine priority levels for UE devices 102. For example, when an authentication request is received from the BNG/WAG 110, the priority device recognition and validation module 362 may validate the credentials, while the priority device policy retrieval and assignment module 364 may determine the appropriate priority level based on the validated credentials.

The priority device policy configuration module 366 may then use the determined priority level to generate the authentication response. This response may include specific policy information, such as quality of service UE parameters or UE assignments, based on the priority level of the authenticated UE device 102.

The modules within the machine readable instructions 356 may work together to provide efficient and secure authentication and authorization for priority devices in the virtual CPE network architecture 100. For example, in instances in which a priority UE device 102 attempts to connect to the network, the AAA server 114 may quickly validate its credentials, determine its priority level, and communicate the appropriate policy information to the BNG/WAG 110, ensuring that the device receives the correct level of network service and prioritization.

The electronic storage 308 may include non-transitory storage media that electronically stores information. The electronic storage media of electronic storage 308 may include one or both system storage that is provided integrally (i.e., substantially non-removable) and/or removable storage that is removably connectable to the AAA server 114 (e.g., via a USB port, a firewire port, etc.). Electronic storage 358 may include one or more virtual storage resources (e.g., cloud storage, a virtual private network, and/or other virtual storage resources). Electronic storage 358 may store software algorithms, information determined by the processing system(s) 354, priority and communication policy information received from the BNG/WAG or AAA server, or other information that enables the access point 104 to function as described herein.

The description of the functionality provided by the different modules 360-366 is for illustrative purposes, and is not intended to be limiting, as any of modules 320-366 may provide more or less functionality than is described. For example, one or more of the modules 320-366 may be eliminated, and some or all of a module's functionality may be provided by other modules. As another example, the processing system(s) 354 may be configured to execute one or more additional modules that may perform some or all of the functionality of the modules 320-366.

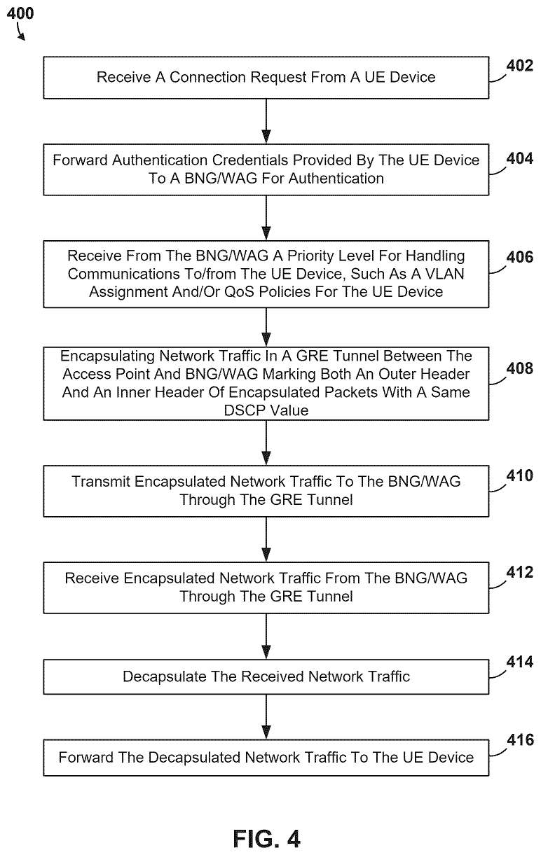

FIG. 4 is a process flow diagram illustrating a method 400 that may be performed by an access point (e.g., 104) for supporting priority communications by a priority UE device (e.g., 102) according to some embodiments. With reference to FIGS. 1A-4, the method 400 may be performed in a processing system (e.g., 304) on an access point implementing software modules as described with reference to FIG. 3A. Means for performing the functions of the operations in the method 400 may include a processing system including one or more processors and other components described herein. Further, one or more processors of a processing system may be configured with software or firmware to perform some or all of the operations of the method 400. To encompass the alternative configurations enabled in various embodiments, the hardware implementing any or all of the method 400 is referred to herein as a “processing system.”

In block 402, the processing system of the wireless access point 104 may receive a connection request from a priority UE device 102, which may be considered a UE device in this context. The connection request may include UE credentials such as a certificate, which may be encrypted using Public Key Infrastructure (PKI) encryption. This may initiate the process of authenticating and prioritizing the UE device within the network.

In block 404, the processing system may forward authentication credentials provided by the priority UE device 102 to the BNG/WAG 110 for authentication. These credentials may be used to determine whether the UE device is a priority device eligible for enhanced network services. In some embodiments, the processing system may include the NAI of the UE device in the information forwarded to the BNG/WAG 110.

In block 406, the processing system may receive a priority level from the BNG/WAG 110 for handling communications to and from the priority UE device 102. This priority level may be based on the authentication response received from the AAA server 114, which may have consulted the network subscriber database 116 or the agency priority device database 118 to verify the device's credentials. The priority level may include a UE assignment for the priority UE device 102. The wireless access point 104 may apply this VLAN assignment to network traffic associated with the priority UE device 102. Additionally, the priority level may include quality of service UE policies for the priority UE device 102. The processing system may apply these QoS policies to network traffic associated with the priority UE device 102, potentially affecting factors such as bandwidth allocation, packet prioritization, or traffic shaping.

In block 408, the processing system may encapsulate network traffic in the GRE tunnel 152 between the wireless access point 104 and the BNG/WAG 110. During this encapsulation process, the wireless access point 104 may mark both an outer header and an inner header of encapsulated packets with the same DSCP value. Marking the outer header with the same DSCP value as the inner header may ensure that the priority information is preserved throughout the network transmission. In these operations, the processing system may copy the DSCP value from the inner header to the outer header during the encapsulation process to further ensure the integrity and priority of the data as it moves through various network segments.

In block 410, the wireless access point processing system may transmit the encapsulated network traffic to the BNG/WAG 110 through the GRE tunnel 152. This transmission may allow the prioritized traffic to traverse the access network core 108 while maintaining its priority status.

In block 412, the wireless access point 104 may receive encapsulated network traffic from the BNG/WAG 110 through the GRE tunnel 152. This may represent return traffic or responses to the initial communication from the priority UE device 102.

In block 414, the processing system may decapsulate the received network traffic. This operation may involve removing the outer header added during the GRE encapsulation process while preserving the original packet information and priority markings.

In block 416, the wireless access point processing system may forward the decapsulated network traffic to the priority UE device 102 via Wi-Fi communication links. This operation ensures that prioritized incoming communication reaches its intended destination of the priority UE device.

In some embodiments, the BNG/WAG 110 may send quality of service UE policies to the wireless access point 104. These QoS policies may be determined by the BNG/WAG 110 based on the priority level assigned to the priority UE device 102. The wireless access point 104 may apply these QoS policies to the network traffic associated with the priority UE device 102, ensuring appropriate prioritization throughout the network path.

The BNG/WAG 110 may generate a UE assignment for the priority UE device 102 based on the priority level. This VLAN assignment may be used to segregate priority traffic from non-priority traffic within the network. The BNG/WAG 110 may send this VLAN assignment to the wireless access point 104, which may then apply the assignment to the network traffic associated with the priority UE device 102.

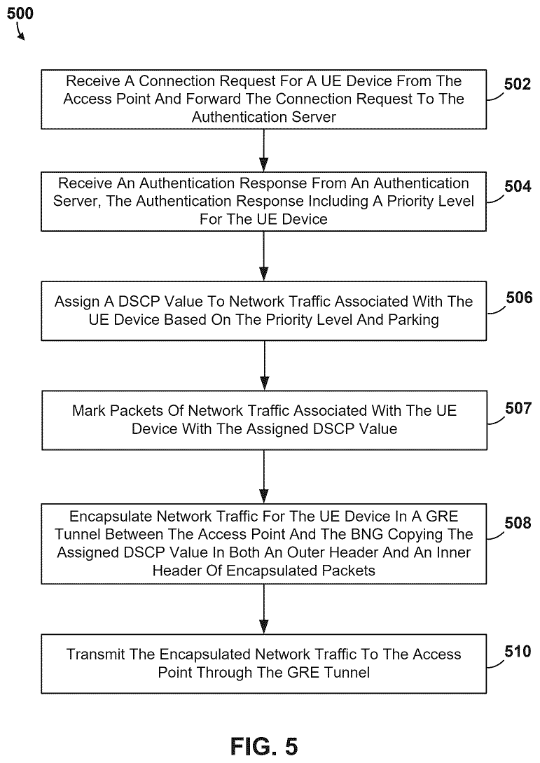

FIG. 5 is a process flow diagram illustrating a method 500 that may be performed by BNG/WAG (e.g., 110) for supporting priority communications by a priority UE device (e.g., 102) according to some embodiments. With reference to FIGS. 1A-5, the method 500 may be performed in a processing system (e.g., 334) of a BNG/WAG implementing software modules as described with reference to FIG. 3B. Means for performing the functions of the operations in the method 500 may include a processing system including one or more processors and other components described herein. Further, one or more processors of a processing system may be configured with software or firmware to perform some or all of the operations of the method 500. To encompass the alternative configurations enabled in various embodiments, the hardware implementing any or all of the method 500 is referred to herein as a “processing system.”

In block 502, the BNG/WAG 110 may receive a connection request for a priority UE device 102 from the wireless access point 104.

The BNG/WAG processing system may forward this connection request to the AAA server 114 for authentication and priority determination. The connection request may include UE device credentials, such as a digital certificate, which can be used for authenticating the UE device as a priority device. In some embodiments, the BNG/WAG processing system may include the NAI of the UE device in the connection request.

In block 504, the BNG/WAG processing system may receive an authentication response from the AAA server 114. This authentication response may include a priority level for the priority UE device 102. The priority level may be determined based on the credentials provided by the priority UE device 102 and verified against the network subscriber database 116 or the agency priority device database 118. In some embodiments, the virtual CPE network system may support multiple priority tiers for emergency services. For example, the priority levels may include gold, silver, and bronze tiers, with gold representing the highest priority for critical emergency responders, silver for essential personnel, and bronze for support staff. In some embodiments, the authentication response may include network policies to use for communications with the priority UE device 102, such as a VLAN value, a DSCP value, and/or other policies.

In block 506, the processing system may assign a DSCP value to network traffic associated with the priority UE device 102 based on the priority level received in the authentication response. The DSCP value may be used to indicate the relative importance of the network traffic throughout the network path.

In some cases, the processing system may implement hierarchical Quality of Service UE to differentiate between voice and data traffic within the same priority tier. For example, voice traffic from a gold-tier device may receive higher priority than data traffic from the same device, ensuring that vital voice communications are prioritized during emergency situations.

In block 507, the processing system may mark packets of network traffic associated with the priority UE device 102 with the assigned DSCP value.

In block 508, the processing system may encapsulate the network traffic packets in the GRE tunnel 152 between the wireless access point 104 and the BNG/WAG 110. This may be accomplished by the processing system performing operations of priority traffic encapsulation module 346 as described. During this encapsulation process, the processing system copy the assigned DSCP value from the marked inner header of packets encapsulated and use the same DSCP value to mark the outer header of encapsulated packets. Copying the assigned DSCP value in both outer and inner headers of encapsulated packets in this manner may ensure that the priority information is preserved throughout the network transmission.

In block 510, the BNG/WAG 110 may transmit the encapsulated packets of network traffic to the wireless access point 104 through the GRE tunnel 152. This transmission may allow the prioritized traffic to traverse the access network core 108 while maintaining its priority status.

Additionally, the processing system may perform operations of the priority traffic contention and service differentiation module 348 in conjunction with operations of the priority traffic encapsulation module 346 to manage the prioritization of network traffic based on the assigned DSCP values and implement the hierarchical QoS policies. These operations by the processing system may ensure that higher-priority traffic, such as voice communications from gold-tier emergency responders, receives preferential treatment over lower-priority traffic, even within the same priority tier.

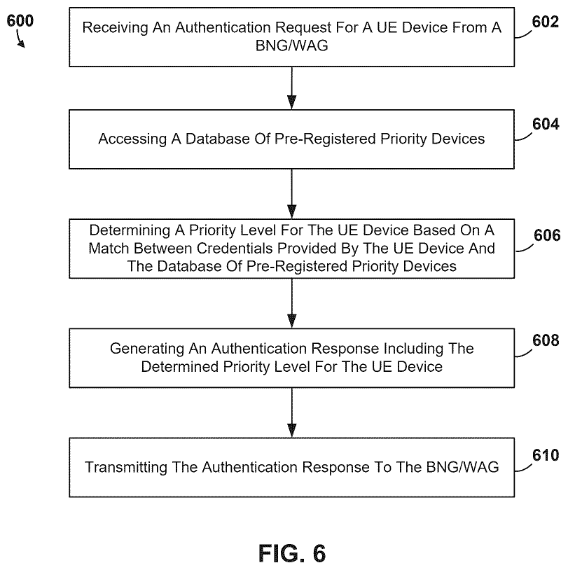

FIG. 6 is a process flow diagram illustrating a method 600 that may be performed by an AAA server (e.g., 114) for authenticating and supporting priority communications with a priority UE device (e.g., 102) according to some embodiments. With reference to FIGS. 1A-6, the method 600 may be performed in a processing system (e.g., 354) of a BNG/WAG implementing software modules as described with reference to FIG. 3C. Means for performing the functions of the operations in the method 600 may include a processing system including one or more processors and other components described herein. Further, one or more processors of a processing system may be configured with software or firmware to perform some or all of the operations of the method 600. To encompass the alternative configurations enabled in various embodiments, the hardware implementing any or all of the method 600 is referred to herein as a “processing system.”

In block 602, the processing system of the AAA server 114 may receive an authentication request for a UE device from the BNG/WAG 110. This authentication request may be initiated when a UE device attempts to connect to the network through the wireless access point 104. The operations performed in block 602 by the processing system may include receiving a certificate of the UE device, which may be used to verify the device's identity and priority status.

In block 604, the AAA server processing system may access a database of pre-registered priority devices. This database may be the network subscriber database 116 and/or an agency priority device database 118. The processing system may perform operations of the priority device recognition and validation module 362 to retrieve information about registered priority devices. This operation may include the processing system providing a UE certificate or other UE identifying information to support the lookup operations.

In block 606, the processing system may determine a priority level for the UE device based on a match between credentials provided by the UE device and the database of pre-registered priority devices. The processing system may perform operations of the priority device policy retrieval and assignment module 364 to compare the provided credentials against the stored information in the accessed database to assign an appropriate priority level. In some cases, the credentials provided by the UE device may include a digital certificate, in which case the processing system may validate this certificate as part of the authentication process. In some cases, the credentials may include other forms of identification, such as a unique device identifier or a username and password combination.

In block 608, the processing system may generate an authentication response including the determined priority level for the UE device. This may be accomplished by the processing system performing operations of the priority device policy configuration module 366 to create a response message that contains the authentication results and the assigned priority level.

In block 610, the AAA server 114 may transmit the authentication response to the BNG/WAG 110. This operation may complete the authentication process, providing the BNG/WAG 110 with the necessary information to handle the UE device's network traffic appropriately based on its priority level.

In some embodiments, the operations performed in block 602 by the processing system may include inspecting the realm field of the UE device's NAI for a priority indication (e.g., network domain, subdomain code, etc.). In such embodiments, the processing system may perform the rest of the operations in the method 600 in response to or based upon a priority indication that is included in the NAI realm field. In particular, when the UE device's NAI is included in the authentication request, the processing system of the AAA server 114 may perform the operations of accessing the database in block 604 and determining the priority level of the UE in block 606 in response to and/or based on the priority indication included in the NAI realm field.

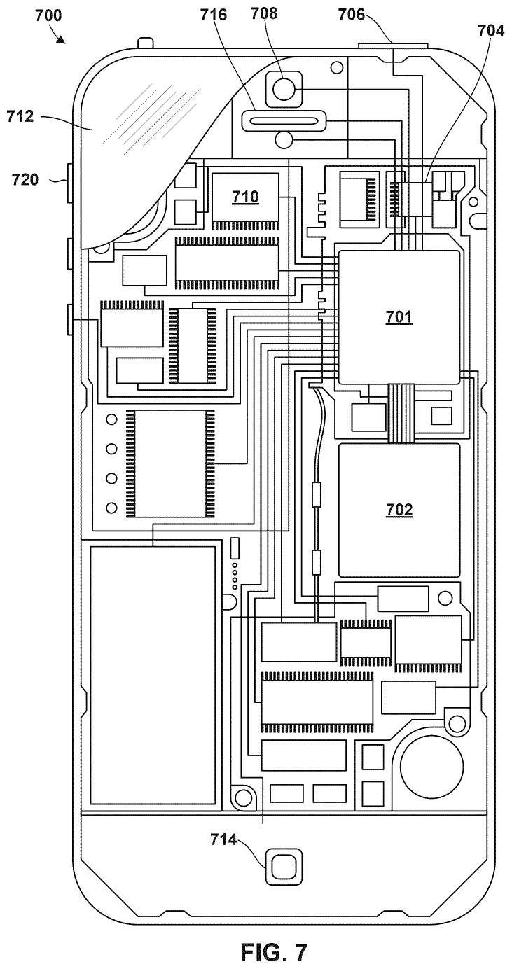

In some embodiments, the virtual CPE network architecture 100 may include a priority UE device in the form of a mobile device 700 illustrated in FIG. 7. The mobile device 700 may be a UE device capable of connecting to the wireless access point 104 and participating in prioritized emergency services communications as described herein.

The mobile device 700 may include a processing system 701 positioned within the device housing. The processing system 701 may be responsible for executing instructions and managing the operations of the mobile device 700. In some cases, the processing system 701 may be a multi-core processor capable of handling complex computations and multitasking operations.

A memory module 702 may be positioned within the device housing, in proximity to the processing system 701. The memory module 702 may store data, instructions, and applications necessary for the operation of the mobile device 700. In some embodiments, the memory module 702 may include both volatile and non-volatile memory components to support various storage requirements.

The mobile device 700 may include a Wi-Fi transceiver 704 connected to an antenna 706. The Wi-Fi transceiver 704 and antenna 706 may enable wireless communication capabilities, allowing the mobile device 700 to connect to the wireless access point 104 and participate in prioritized network communications as described.

A camera 708 may be positioned in the upper portion of the mobile device 700. The camera 708 may be used for various functions, including capturing images or scanning QR codes that may contain network provisioning information or authentication credentials.

The mobile device 700 may incorporate an inertial measurement unit (IMU) 710 within the device housing. The IMU 710 may provide motion sensing capabilities that could be utilized in certain authentication scenarios or user interaction methods during the network provisioning process.

A display screen 712 may be provided on the front surface of the mobile device 700. The display screen 712 may be used to present user interfaces, display network connection status, and show other information related to the prioritized network access.

The mobile device 700 may include a microphone 714 positioned within the device housing. The microphone 714 may be used for voice commands or audio-based authentication during the network connection and prioritization process.

A speaker 716 may be incorporated into the mobile device 700. The speaker 716 may provide audio feedback or instructions to the user during the network provisioning and prioritization process.

An input button 720 may be situated along a side of the mobile device 700. The input button 720 may provide an additional means for user interaction, such as initiating network scans or confirming actions related to priority network access.

The components of the mobile device 700 may work together to enable seamless integration with the virtual CPE network architecture 100. For example, the Wi-Fi transceiver 704 and antenna 706 may facilitate the transmission of authentication credentials to the wireless access point 104. The processing system 701 and memory module 702 may manage the encapsulation and prioritization of network traffic according to the assigned DSCP values.

In some embodiments, the mobile device 700 may store digital certificates or other authentication credentials in the memory module 702. These credentials may be used by the AAA server 114 to verify the device's priority status and assign appropriate QoS policies as described herein.

The display screen 712 may present information about the current network connection status, including indications of priority service levels. The display screen 712 may be touch-sensitive in which case the screen may serve as a user input device. The microphone 714 and speaker 716 may be utilized for voice-based emergency communications that receive prioritized treatment through the network.

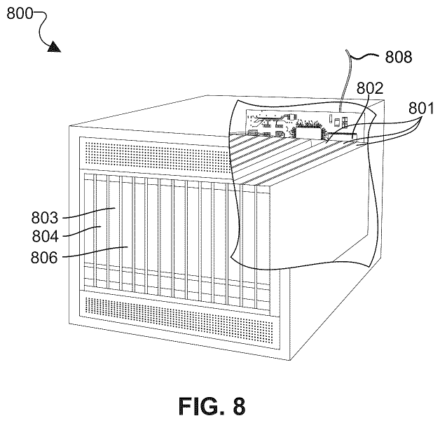

In some embodiments, the BNG/WAG 110 and the AAA 104 within the virtual CPE network architecture 100 may be implemented in a computing device such as a server 800 as illustrated in FIG. 8. Such a server 800 may be configured to support various network functions, such as network management functions and/or authentication, authorization, and accounting (AAA) services, as well as database management for priority device information.

A server 800 may include a processing system 801 positioned in the upper portion of the server housing. The processing system 801 may be responsible for executing instructions and managing the operations of the server 800. In some cases, the processing system 801 may be a multi-core processor capable of handling complex computations and multitasking operations related to network management and prioritization.

A memory 802 may be located adjacent to the processing system 801 within the server housing. The memory 802 may store data, instructions, and applications necessary for the operation of the server 800. In some embodiments, the memory 802 may include both volatile and non-volatile memory components to support various storage requirements for network operations and user authentication data.

The server 800 may include a storage module 803 that that may contain multiple storage slots 804 arranged in a vertical configuration. Each storage slot 804 may accommodate storage devices that store user credentials, network configuration parameters, and other data necessary for managing priority device access and network prioritization.

A network interface 806 may be incorporated into the server 800, positioned adjacent to the storage module 803. The network interface 806 may connect to a network connection 808, enabling communication with other components of the virtual CPE network architecture 100, such as the BNG/WAG 110, the wireless access point 104, and the priority UE device 102.

The network interface 806 may enable the server 800 to communicate with other network elements (e.g., the BNG/WAG 110, AAA server 114, etc.). In some cases, the network interface 806 may also facilitate communication with external agency databases for verifying emergency services credentials.

Implementation examples are described in the following paragraphs. While some of the following implementation examples are described in terms of example methods, further example implementations may include: the example methods discussed in the following paragraphs implemented by a computing system including a processing system configured (e.g., with processor-executable instructions) to perform operations of the methods of the following implementation examples; and the example methods discussed in the following paragraphs may be implemented as a non-transitory processor-readable storage medium having stored thereon processor-executable instructions configured to cause a processing system of a computing system to perform the operations of the methods of the following implementation examples.

Example 1: A system for prioritizing emergency services communications in a network, including: an access point configured to receive a connection request from a UE device; an authentication server configured to authenticate the UE device based on credentials provided by the UE device; and a broadband network gateway (BNG) and/or wireless access gateway (WAG) (together BNG/WAG) configured to: receive an authentication response from the authentication server, the authentication response including a priority level for the UE device; assign a DSCP value to network traffic associated with the UE device based on the priority level; mark packets of network traffic associated with the UE device with the assigned DSCP value; and encapsulate the network traffic in a GRE tunnel between the access point and the BNG/WAG copying the DSCP value in both an outer header and an inner header of encapsulated packets.

Example 2: The system of example 1, wherein the authentication server is configured to: access a database of pre-registered priority devices; and determine the priority level for the UE device based on a match between the credentials provided by the UE device and the database of pre-registered priority devices.

Example 3: The system of any of examples 1-2, wherein the credentials provided by the UE device include a digital certificate.

Example 4: The system of any of examples 1-3, wherein the BNG/WAG is further configured to: assign the UE device to a UE based on the priority level; and apply quality of service UE policies to the network traffic associated with the UE device based on the assigned VLAN.

Example 5: The system of any of examples 1-4, wherein the BNG/WAG is further configured to: receive network traffic from a CDN addressed to the UE device; encapsulate the network traffic from the CDN in the GRE tunnel copying the assigned DSCP value in both the outer header and the inner header of encapsulated packets; and forward the encapsulated network traffic to the access point.

Example 6: The system of any of examples 1-5, wherein the BNG/WAG is further configured to perform network address and port translation (NAPT) on the network traffic from the CDN before encapsulating it in the GRE tunnel.

Example 7: A method for prioritizing emergency services communications in a network system including: receiving, at an access point, a connection request from a UE device and forwarding credentials of the UE in the connection request to a BNG/WAG for authentication; forwarding by the BNG/WAG the credentials of the UE to an authentication server for authentication as a priority device; authenticating the UE device based on the credentials by the authentication server by accessing a database of priority devices, and forwarding the authentication results in an authentication response to the BNG/WAG, the authentication response including a priority level for the UE device; assigning by the BNG/WAG a DSCP value to network traffic associated with the UE device based on the priority level in the authentication response; marking packets of network traffic associated with the UE device with the assigned DSCP value; and encapsulating the network traffic in a GRE tunnel between the access point and the BNG/WAG copying the assigned DSCP value in both an outer header and an inner header of encapsulated packets.

Example 8: A method performed by an access point for prioritizing emergency services communications in a network including: receiving a connection request from a UE device; forwarding authentication credentials provided by the UE device to a BNG/WAG for authentication; receiving from the BNG/WAG a priority level for handling communications to/from the UE device; encapsulating network traffic in a GRE tunnel between the access point and BNG/WAG marking both an outer header and an inner header of encapsulated packets with a same DSCP value; and transmitting the encapsulated network traffic to the BNG/WAG through the GRE tunnel.

Example 9: The method of example 8, further including: receiving encapsulated network traffic from the BNG/WAG through the GRE tunnel; decapsulating the received network traffic; and forwarding the decapsulated network traffic to the UE device.

Example 10: The method of any of examples 8-9, further including: receiving a UE assignment for the UE device from the BNG/WAG; and applying the VLAN assignment to the network traffic associated with the UE device.

Example 11: The method of any of examples 8-10, further including: receiving quality of service UE policies for the UE device from the BNG/WAG; and applying the QoS policies to the network traffic associated with the UE device.

Example 12: The method of any of examples 8-11, wherein encapsulating the network traffic includes: adding the outer header to the network traffic while preserving the inner header; and copying the DSCP value from the inner header to the outer header.

Example 13: A method performed by a BNG/WAG for prioritizing emergency services communications in a network including: receiving an authentication response from an authentication server, the authentication response including a priority level for a UE device; assigning a DSCP value to network traffic associated with the UE device based on the priority level; marking packets of network traffic associated with the UE device with the assigned DSCP value; encapsulating the network traffic in a GRE tunnel between an access point and the BNG/WAG copying the DSCP value in both an outer header and an inner header of encapsulated packets; and transmitting the encapsulated network traffic to the access point through the GRE tunnel.

Example 14: The method of example 13, further including: assigning the UE device to a UE based on the priority level; and applying quality of service UE policies to the network traffic associated with the UE device based on the assigned VLAN.

Example 15: The method of any of examples 13-14, further including: encapsulating network traffic received from a CDN addressed to the UE device in the GRE tunnel copying the assigned DSCP value in both the outer header and the inner header of encapsulated packets; and forwarding the encapsulated network traffic to the access point.

Example 16: The method of any of examples 13-15, further including performing network address and port translation (NAPT) on the network traffic from the CDN before encapsulating network traffic packets in the GRE tunnel.

Example 17: The method of any of examples 13-16, further including: receiving a connection request for the UE device from the access point; and forwarding the connection request to the authentication server.

Example 18: The method of any of examples 13-17, further including: generating a VLAN assignment for the UE device based on the priority level; and sending the VLAN assignment to the access point.

Example 19: The method of any of examples 13-18, further including: determining QoS policies for the UE device based on the priority level; and sending the QoS policies to the access point.

Example 20: A method performed by an authentication, authorization, and accounting (AAA) server for prioritizing emergency services communications in a network including: receiving an authentication request for a UE device from a BNG/WAG; accessing a database of pre-registered priority devices; determining a priority level for the UE device based on a match between credentials provided by the UE device and the database of pre-registered priority devices; generating an authentication response including the determined priority level for the UE device; and transmitting the authentication response to the BNG/WAG.

Example 21, the method of example 20 in which the authentication request includes a NAI of the UE device, the method further including accessing the database and determining the priority level of the UE in response to and/or based on a priority indication included in the NAI realm field.

As used in this application, terminology such as “unit,” “component,” “module,” “system,” etc., is intended to encompass a software-implemented or computer-related entity. These entities may involve, among other possibilities, hardware, firmware, a blend of hardware and software, software alone, or software in an operational state. As examples, a component may encompass a running process on a processor, the processing system itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, and memory interactions, among other known methods of network, computer, processor, or process-related communications.

A number of different types of memories and memory technologies are available or contemplated in the future, any or all of which may be included and used in systems and computing devices that implement the various embodiments.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, or any other medium that may be used to store target program code in the form of instructions or data structures and that may be accessed by a computer. Modern technologies, such as cloud-based storage solutions, including infrastructure-as-a-service (IaaS) platforms, may offer scalable and distributed options for storing and accessing program code.

In addition, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing systems (GPUs) and tensor processing systems (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

We claim:

1. A system for prioritizing emergency services communications in a network, comprising:
an access point configured to receive a connection request from a user equipment (UE) device;
an authentication server configured to authenticate the UE device based on credentials provided by the UE device; and
a broadband network gateway/wireless access gateway (BNG/WAG) configured to:
receive an authentication response from the authentication server, the authentication response including a priority level for the UE device;
assign a differentiated services code point (DSCP) value to network traffic associated with the UE device based on the priority level;
mark packets of network traffic associated with the UE device with the assigned DSCP value; and
encapsulate the network traffic in a Generic Routing Encapsulation (GRE) tunnel between the access point and the BNG/WAG copying the DSCP value in both an outer header and an inner header of encapsulated packets.

2. The system of claim 1, wherein the authentication server is configured to:
access a database of pre-registered priority devices; and
determine the priority level for the UE device based on a match between the credentials provided by the UE device and the database of pre-registered priority devices.

3. The system of claim 2, wherein the credentials provided by the UE device comprise a digital certificate.

4. The system of claim 1, wherein the BNG/WAG is further configured to:
assign the UE device to a virtual local area network (VLAN) based on the priority level; and
apply quality of service (QoS) policies to the network traffic associated with the UE device based on the assigned VLAN.

5. The system of claim 1, wherein the BNG/WAG is further configured to:
receive network traffic from a content delivery network (CDN) addressed to the UE device;
encapsulate the network traffic from the CDN in the GRE tunnel copying the assigned DSCP value in both the outer header and the inner header of encapsulated packets; and
forward the encapsulated network traffic to the access point.

6. The system of claim 5, wherein the BNG/WAG is further configured to perform network address and port translation (NAPT) on the network traffic from the CDN before encapsulating it in the GRE tunnel.

7. A method for prioritizing emergency services communications in a network system, comprising:
receiving, at an access point, a connection request from a user equipment (UE) device and forwarding credentials of the UE in the connection request to a broadband network gateway/wireless access gateway (BNG/WAG) for authentication;
forwarding by the BNG/WAG the credentials of the UE to an authentication server for authentication as a priority device;
authenticating the UE device based on the credentials by the authentication server by accessing a database of priority devices, and forwarding the authentication results in an authentication response to the BNG/WAG, the authentication response including a priority level for the UE device;
assigning by the BNG/WAG a differentiated services code point (DSCP) value to network traffic associated with the UE device based on the priority level in the authentication response;
marking packets of network traffic associated with the UE device with the assigned DSCP value; and
encapsulating the network traffic in a Generic Routing Encapsulation (GRE) tunnel between the access point and the BNG/WAG copying the assigned DSCP value in both an outer header and an inner header of encapsulated packets.

8. A method performed by an access point for prioritizing emergency services communications in a network, comprising:
receiving a connection request from a user equipment (UE) device;
forwarding authentication credentials provided by the UE device to a broadband network gateway/wireless access gateway (BNG/WAG) for authentication;
receiving from the BNG/WAG a priority level for handling communications to/from the UE device;
encapsulating network traffic in a Generic Routing Encapsulation (GRE) tunnel between the access point and BNG/WAG marking both an outer header and an inner header of encapsulated packets with a same differentiated services code point (DSCP) value; and
transmitting the encapsulated network traffic to the BNG/WAG through the GRE tunnel.

9. The method of claim 8, further comprising:
receiving encapsulated network traffic from the BNG/WAG through the GRE tunnel;
decapsulating the received network traffic; and
forwarding the decapsulated network traffic to the UE device.

10. The method of claim 8, further comprising:
receiving a virtual local area network (VLAN) assignment for the UE device from the BNG/WAG; and
applying the VLAN assignment to the network traffic associated with the UE device.

11. The method of claim 8, further comprising:
receiving quality of service (QoS) policies for the UE device from the BNG/WAG; and
applying the QoS policies to the network traffic associated with the UE device.

12. The method of claim 8, wherein encapsulating the network traffic comprises:
adding the outer header to the network traffic while preserving the inner header;
and copying the DSCP value from the inner header to the outer header.

13. A method performed by a broadband network gateway/wireless access gateway (BNG/WAG) for prioritizing emergency services communications in a network, comprising:
receiving an authentication response from an authentication server, the authentication response including a priority level for a user equipment (UE) device;
assigning a differentiated services code point (DSCP) value to network traffic associated with the UE device based on the priority level;
marking packets of network traffic associated with the UE device with the assigned DSCP value;
encapsulating the network traffic in a Generic Routing Encapsulation (GRE) tunnel between an access point and the BNG/WAG copying the DSCP value in both an outer header and an inner header of encapsulated packets; and
transmitting the encapsulated network traffic to the access point through the GRE tunnel.

14. The method of claim 13, further comprising:
assigning the UE device to a virtual local area network (VLAN) based on the priority level; and
applying quality of service (QoS) policies to the network traffic associated with the UE device based on the assigned VLAN.

15. The method of claim 13, further comprising:
encapsulating network traffic received from a content delivery network (CDN) addressed to the UE device in the GRE tunnel copying the assigned DSCP value in both the outer header and the inner header of encapsulated packets; and
forwarding the encapsulated network traffic to the access point.

16. The method of claim 15, further comprising performing network address and port translation (NAPT) on the network traffic from the CDN before encapsulating network traffic packets in the GRE tunnel.

17. The method of claim 13, further comprising:
receiving a connection request for the UE device from the access point; and
forwarding the connection request to the authentication server.

18. The method of claim 13, further comprising:
generating a VLAN assignment for the UE device based on the priority level; and
sending the VLAN assignment to the access point.

19. The method of claim 13, further comprising:
determining QoS policies for the UE device based on the priority level; and
sending the QoS policies to the access point.

20. A method performed by an authentication, authorization, and accounting (AAA) server for prioritizing emergency services communications in a network, comprising:
receiving an authentication request for a user equipment (UE) device from a broadband network gateway/wireless access gateway (BNG/WAG);
accessing a database of pre-registered priority devices;
determining a priority level for the UE device based on a match between credentials provided by the UE device and the database of pre-registered priority devices;
generating an authentication response including the determined priority level for the UE device; and
transmitting the authentication response to the BNG/WAG.

21. The method of claim 20, wherein the authentication request includes a Network Access Identifier (NAI) of the UE device, the method further comprising accessing the database and determining the priority level of the UE in response to a priority indication included in the NAI realm field.
